(19) United States
(12) Patent Application Publication
(10) Pub. No.: US 2026/0332885 A1
(43) Pub. Date: Oct. 22, 2026

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: KATSUYA IWATA, Kanagawa (JP)

(21) Appl. No.: 19/634,330

(22) Filed: Mar. 31, 2026

(30) Foreign Application Priority Data
Apr. 18, 2025 (JP) 2025-068955

(51) Int. Cl. H04N 23/60; G06F 40/40; G10L 15/26; H04N 21/218; H04N 23/698; H04N 23/90; H04N 23/69; H04N 23/695

(52) U.S. Cl. CPC H04N 23/64; G06F 40/40; G10L 15/26; H04N 21/21805; H04N 23/698; H04N 23/90; H04N 23/69; H04N 23/695

(57) ABSTRACT

An information processing apparatus, identifies a current control parameter for an image capture apparatus, generates text of content of obtained audio, generates question text relating to a next control parameter for the image capture apparatus based on the control parameter and the text, obtains an answer to the question text by inputting the question text into a large language model, and determines a next control parameter for the image capture apparatus based on the answer.

### BACKGROUND

### Field of the Technology

The present disclosure relates to an information processing apparatus, an information processing method, and a non-transitory computer-readable storage medium.

### Description of the Related Art

Video distribution services for streaming videos of conversations, interviews, and the like have recently been increasing, leading to a demand for ways to save labor relating to shooting and distributing. When distributing video captured using a plurality of cameras, a person must select the video they wish to show the viewers from among the videos from the plurality of cameras and manually switch the output video so that the selected video is distributed. Thus, methods for automating this video output switching have been proposed.

For example, in the technology described in Japanese Patent Laid-Open No. 2005-295431, a subject person and a keyword in content spoken by that person are registered in advance, and video switching is performed to output the camera video that shows the speaker when the keyword is spoken.

Another proposed method includes automatically controlling a single camera that can pan, tilt, and zoom while distributing video. For example, in the technology described in Japanese Patent Laid-Open No. 2010-109898, the name and position of a subject person are registered in advance, and in a case where the registered name of the subject person is spoken by someone, pan and tilt control is performed to capture this person.

In yet another proposed method, partial video is automatically extracted and distributed from a 360-degree video obtained by joining together video captured in a wide area by a plurality of cameras. For example, in the proposed technology, a speaker is identified via voice recognition, and video of the speaker is automatically extracted.

In the technology described in Japanese Patent Laid-Open No. 2005-295431 and Japanese Patent Laid-Open No. 2010-109898, there is an issue in that, in a situation where it is not known which camera can shoot the video scene to be distributed, subject person information cannot be pre-registered for the video scene, and such a situation cannot be handled. Also, with the method of showing the speaker, there is an issue in that a video of the reaction of the non-speakers cannot be distributed.

### SUMMARY

According to an embodiment of the present disclosure, an information processing apparatus that appropriately performs image capture apparatus parameter control is provided.

According to one embodiment of the present disclosure, an information processing apparatus identifies a current control parameter for an image capture apparatus, generates text of content of obtained audio, generates question text relating to a next control parameter for the image capture apparatus based on the control parameter and the text, obtains an answer to the question text by inputting the question text into a large language model, and determines a next control parameter for the image capture apparatus based on the answer.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic view illustrating an example of a configuration of an image capture system according to a first embodiment.

FIG. 2 is a block diagram illustrating an example of a hardware configuration of the image capture system according to the first embodiment.

FIG. 3 is a block diagram illustrating an example of a functional configuration of the image capture system according to the first embodiment.

FIG. 4 is a diagram illustrating an example of a settings screen for shot names according to the first embodiment.

FIG. 5 is a diagram illustrating an example of a question text template according to the first embodiment.

FIG. 6 is a diagram illustrating an example of answer text according to the first embodiment.

FIG. 7 is a flowchart illustrating an example of information processing according to the first embodiment.

FIG. 8 is a diagram illustrating another example of a question text template according to the first embodiment.

FIG. 9 is a diagram illustrating another example of an answer text according to the first embodiment.

FIG. 10 is a schematic view illustrating an example of a configuration of an image capture system according to a second embodiment.

FIG. 11 is a block diagram illustrating an example of a hardware configuration of the image capture system according to the second embodiment.

FIG. 12 is a block diagram illustrating an example of a functional configuration of the image capture system according to the second embodiment.

FIG. 13 is a diagram illustrating an example of a settings screen for shot names according to the second embodiment.

FIG. 14 is a flowchart illustrating an example of information processing according to the second embodiment.

FIG. 15 is a schematic view illustrating an example of a configuration of an image capture system according to a third embodiment.

FIG. 16 is a diagram for describing frame extraction according to the third embodiment.

FIG. 17 is a block diagram illustrating an example of a hardware configuration of the image capture system according to the third embodiment.

FIG. 18 is a block diagram illustrating an example of a functional configuration of the image capture system according to the third embodiment.

FIG. 19 is a flowchart illustrating an example of information processing according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

An information processing apparatus according to the first embodiment identifies the current control parameter relating to an image capture apparatus and generates text of the content of the obtained audio. Next, the information processing apparatus, based on the control parameter and the text, generates question text for the next control parameter relating to the image capture apparatus and obtains an answer to the question text by inputting the generated question text into a large language model. Also, the information processing apparatus determines the next control parameter relating to the image capture apparatus based on the answer.

In an image capture system including the information processing apparatus according to the present embodiment, one video stream is selected and output from among video streams from a plurality of image capture apparatuses. In the example described below, as the control parameter (camera control parameter) relating to the image capture apparatus, a parameter for selecting an image capture apparatus to output video, from among the plurality of image capture apparatuses, controlled by the information processing apparatus in such an image capture system is used.

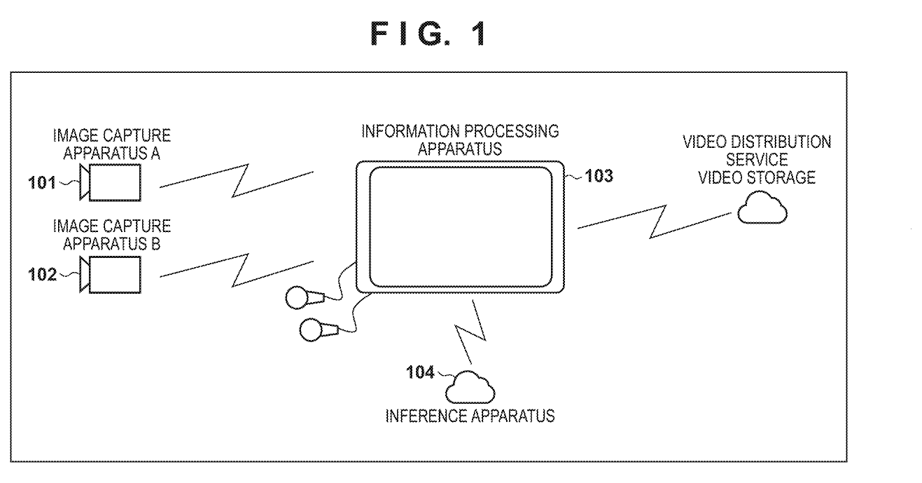

FIG. 1 is a schematic view illustrating an example of an image capture system configuration including an information processing apparatus according to the present embodiment. In the image capture system illustrated in FIG. 1, an image capture apparatus A 101, an image capture apparatus B 102, an information processing apparatus 103, and an inference apparatus 104 are connected in a communication-enabling manner. The image capture apparatus A 101 and the image capture apparatus B 102 are image capture apparatuses connected to a network. Two image capture apparatuses are present in the illustrated example, but this number of not limited in this manner. The information processing apparatus 103 receives video captured by each of the plurality of image capture apparatuses (here, the image capture apparatus A 101 and the image capture apparatus B 102), determines which video to distribute to the viewer from among these videos, and outputs and distributes this video. Here, as the video distribution destination, a video distribution service or a video storage is used.

The information processing apparatus 103, for example, can be a tablet, a smartphone, a PC, a server machine, or a machine on the cloud. Also, the information processing apparatus 103 according to the present embodiment is provided with a microphone for audio input.

The inference apparatus 104 generates an answer to the question text via a large language model. The processing by the inference apparatus 104 will be described below. The inference apparatus 104 may be a cloud service providing an inference function via such a large language model, a workstation, or a PC.

Note that in the example described herein, the information processing apparatus 103 and the inference apparatus 104 are different apparatuses. However, the information processing apparatus 103 may be provided with the functions described as being performed by the inference apparatus 104. Also, in the example described herein, each image capture apparatus and the information processing apparatus 103 are different apparatuses. However, if similar processing can be executed, the information processing apparatus 103 may include an image capture function, and the image capture apparatus may execute a portion of the functions described as being executed by the information processing apparatus 103.

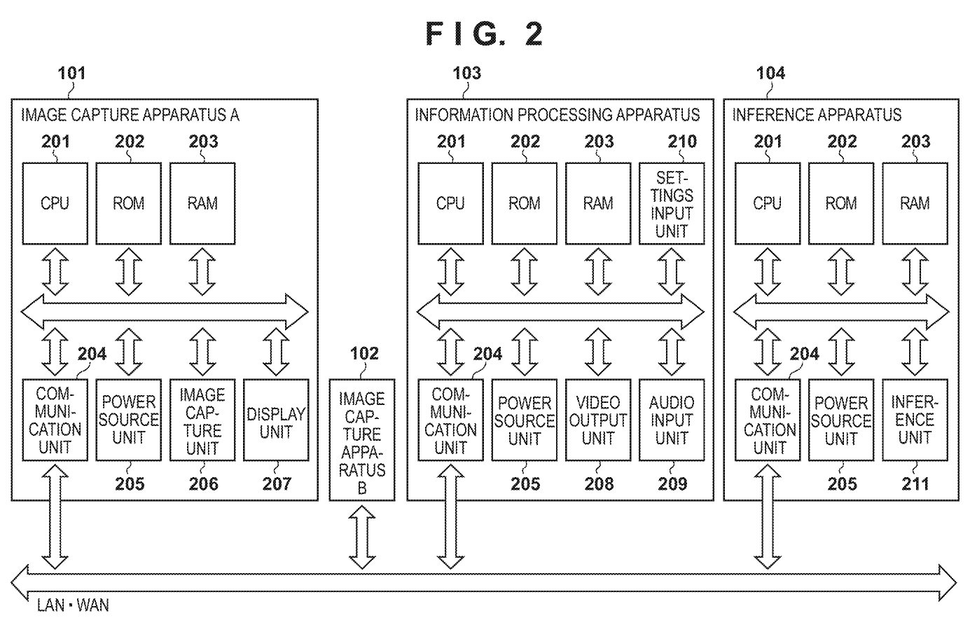

FIG. 2 is a block diagram illustrating an example of a hardware configuration of the image capture system according to the present embodiment. The image capture apparatus A 101 includes a CPU 201, a ROM 202, a RAM 203, a communication unit 204, a power source unit 205, an image capture unit 206, and a display unit 207, and these are all connected via a bus.

The CPU 201 is a control unit including at least one processor or circuit that controls the entire image capture apparatus A 101. The ROM 202 is an electrically erasable and recordable memory that stores constant data for the operations of the CPU 201, programs, and the like. Herein, a program refers to a computer program for executing the various flowcharts described below in the present embodiment. The constant data for the operations of the CPU 201, variable data, programs read out from the ROM 202, and the like are loaded into the RAM 203.

The communication unit 204 is an interface for communicating with an external apparatus such as a network device or a USB device. The communication unit 204 performs data communication via the network and exchanges data with the external apparatus. In FIG. 2, each apparatus is illustrated as communicating via a Local Area Network (LAN), but the apparatuses may be connected using another type of network such as a Wide Area Network (WAN).

The power source unit 205 is a unit that supplies power to the image capture apparatus A 101. The power source unit 205 may be a built-in battery such as a lithium ion battery, may be a removable portable battery, or may be configured to supply power from an AC power source.

The image capture unit 206 is at least one image sensor configured of a CCD or CMOS element that converts an optical image into an electrical signal. The display unit 207 is a unit that enables external display of an image capture file or the status of the apparatus. The display unit 207 can perform display via an LED display or a liquid crystal panel.

The image capture apparatus B 102 is an image capture apparatus with a similar configuration as the image capture apparatus A 101 and thus will not be described as similar processing can be executed. However, as long as similar processing can be executed, the image capture apparatus B 102 does not need to be the same type as the image capture apparatus A 101.

The information processing apparatus 103 includes the CPU 201, the ROM 202, the RAM 203, the communication unit 204, the power source unit 205, a video output unit 208, an audio input unit 209, and a settings input unit 210, and these are all connected via a bus. The CPU 201, the ROM 202, the RAM 203, the communication unit 204, and the power source unit 205 included in the information processing apparatus 103 have a similar function to the components that share their reference number included in the image capture apparatus A 101, but they may be implemented with different types of hardware.

The video output unit 208 externally outputs video or audio signals via Serial Digital Interface (SDI), HDMI (registered trademark), or the like. Also, the video output unit 208 may be an IP video transmission output unit that performs video transmission via a network.

The audio input unit 209 isolates and inputs the audio data of each speaker from the audio of the shooting site. The audio input unit 209, for example, may use a plurality of sound collecting apparatuses (microphones) arranged at the shooting site that are allocated to correspond to each speaker and obtain audio collected from each microphone as spoken data of the corresponding speakers. Also, the audio input unit 209 may use the audio collected using a single microphone and obtain, via software processing, spoken data sorted by audio of the speakers based on the waveform of the audio of the speakers on which training was performed in advance.

The settings input unit 210 receives various types of input from the user. The settings input unit 210 may receive an input of setting values from the user, for example. For example, the settings input unit 210 may be configured of an operation input unit such as a keyboard, mouse, or a touch panel and a display unit such as an LED display or liquid crystal panel. In a case where the information processing apparatus is a tablet or a smartphone, the settings input unit 210 may be a software keyboard. Also, the settings input unit 210 may be implemented as a touch panel or the like with the functions of the video output unit 208.

The inference apparatus 104 includes the CPU 201, the ROM 202, the RAM 203, the communication unit 204, the power source unit 205, and an inference unit 211, and these are all connected via a bus. The CPU 201, the ROM 202, the RAM 203, the communication unit 204, and the power source unit 205 included in the inference apparatus 104 have a similar function to the components that share their reference number included in the image capture apparatus A 101, but they may be implemented with different types of hardware.

The inference unit 211 generates an answer to the question text via a large language model. As the inference unit 211, for example, hardware suitable for inference computations is preferably used.

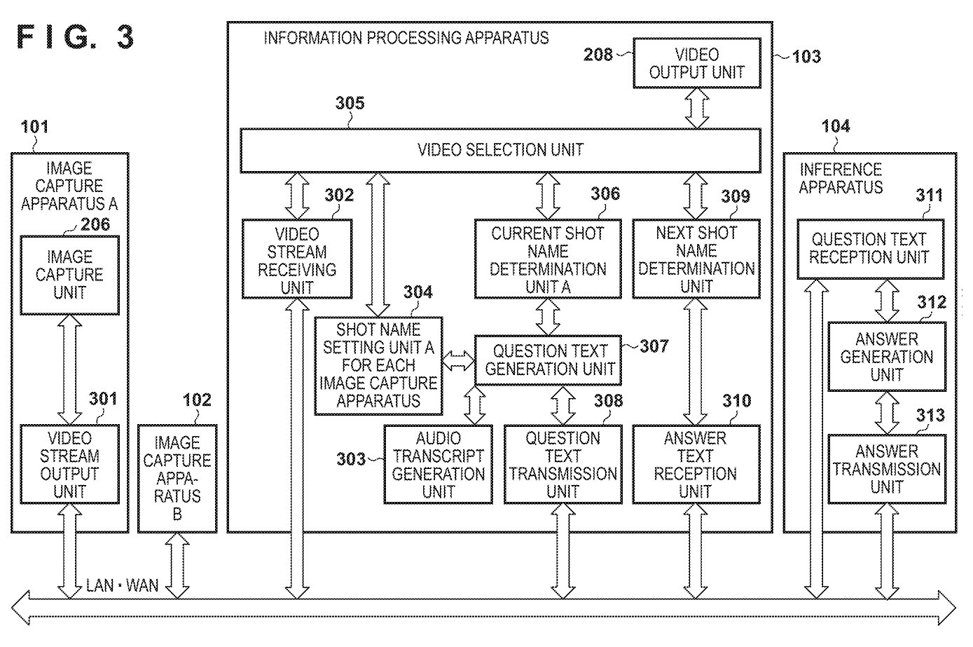

FIG. 3 is a block diagram illustrating an example of a functional configuration of the image capture system according to the present embodiment. The image capture apparatus A 101 includes the image capture unit 206 and a video stream output unit 301. The image capture unit 206 performs image capture as described above. The video stream output unit 301 uses the communication unit 204 to externally transmit video (in this example, video captured by the image capture unit 206). The image capture apparatus B 102 is an image capture apparatus with similar functional units as the image capture apparatus A 101 and thus will not be described since similar processing can be executed. However, as long as similar processing can be executed, the image capture apparatus B 102 does not need to be the same type as the image capture apparatus A 101.

The information processing apparatus 103 includes the video output unit 208, and a video stream receiving unit 302. Also, the information processing apparatus 103 includes, as a question unit that provides questions to the inference apparatus 104, an audio text generation unit 303, a shot name setting unit A 304, a current shot name determination unit A 306, a question text generation unit 307, and a question text transmission unit 308. The information processing apparatus 103 also includes, as a video selection determination unit that determines the video to distribute, a video selection unit 305, a next shot name determination unit 309, and an answer text reception unit 310. The video output unit 208 outputs a video as described above.

The inference apparatus 104 includes a question text reception unit 311, an answer generation unit 312, and an answer transmission unit 313.

The processing executed by each functional unit included in the information processing apparatus 103 and the inference apparatus 104 will be described below. The video stream receiving unit 302 receives the video transmitted from the video stream output unit 301 of the image capture apparatus A 101 and the image capture apparatus B 102. Note that as described above, the number of image capture apparatuses used is not limited to 2, and the number of video streams received from the image capture apparatuses is not limited to two.

The audio text generation unit 303 generates text of the content of the audio obtained by the audio input unit 209. Here, the audio text generation unit 303 transcribes the audio (generates a transcript) based on the audio of each speaker input into the audio input unit 209. The transcript is, for example, configured of a list of pairs including the speaker name and text of the spoken content of the speaker. When simply “audio text” is used below, this refers to the text generated by the audio text generation unit 303.

The shot name setting unit A 304 sets the name of the shot that can be captured by the image capture apparatus from the installation position and field of view of each image capture apparatus. The shot name setting unit A 304, for example, can set the name of a shot based on user input input by a user using the settings input unit 210. The shot name according to the present embodiment is information indicating the image capture apparatus set in association with each image capture apparatus.

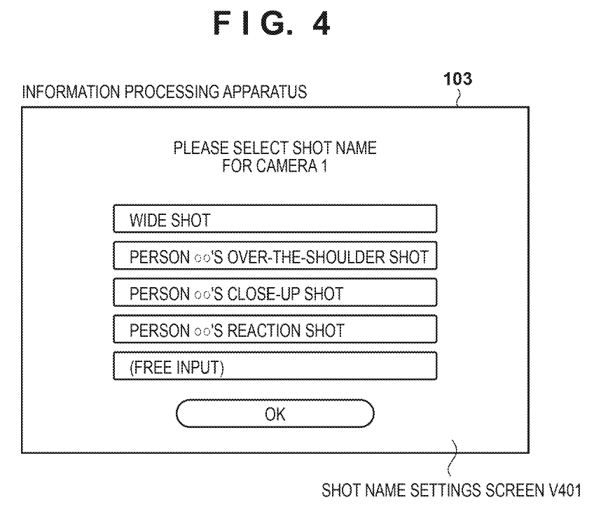

FIG. 4 illustrates an example of a settings screen for setting the shot name. V401 denotes the shot name settings screen of the image capture apparatus A 101. In this example of V401, the shot name setting unit A 304 sets the shot name by receiving a user input of selecting a shot name from options.

An example of a shot name selected from options in this manner will be described below. “Wide shot” is a shot name for shooting at a wide-angle to capture all of the people talking. “Over-the-shoulder shot” is a shot name for shooting a listener from over the shoulder of the person speaking. “Close-up shot” is a shot name for shooting a person at close range. “Reaction shot” is a shot name for shooting the reaction of a listener. In a case where “Over-the-shoulder shot”, “Close-up shot”, and “Reaction shot” are options which can receive text input (via a keyboard, for example) in the “person's name” section, and the name of the speaker to be shot based on this text input can be set in the “person’s name” section.

Also, the “(Free input)” option is an option for the user to freely input text for a shot name that is not one of the options. In a case where this option is selected, the shot name setting unit A 304 receives text input from the user (for example, via a keyboard) and sets the shot name based on the user input. Note that the options illustrated in FIG. 4 are examples, and as long as the shot names are settable, different names may be used and the settings may have a different format.

When an OK button is pressed with a shot name selected, the selected shot name is stored as the shot name of the image capture apparatus A 101. Next, the shot name setting unit A 304 transitions the settings screen to a settings screen for setting the shot name in a similar manner for the image capture apparatus B 102. In this manner, a shot name can be set for all of the connected image capture apparatuses. The shot name set for each of the image capture apparatuses is input into the question text generation unit 307 and the video selection unit 305.

The video selection unit 305 selects one video from among the video streams received by the video stream receiving unit 302 and outputs it to the video output unit 208.

The current shot name determination unit A 306 outputs the shot name set by the shot name setting unit A 304 for the image capture apparatus that is capturing the video stream selected and output by the video selection unit 305.

The current shot name determination unit A 306 according to the present embodiment identifies the current control parameter (current camera control parameter) relating to the image capture apparatus. The camera control parameter according to the present embodiment includes information indicating which image capture apparatus, from among the plurality of image capture apparatuses, has its video being distributed; the orientation of each image capture apparatus (in particular, the image capture apparatus distributing video); the state (control amount) of zoom magnification (pan-tilt-zoom); and a partial region extracted from the video and distributed by the image capture apparatus. Information indicating “which image capture apparatus has its video being distributed” according to the present embodiment may be information indicating which image capture apparatus, from among the image capture apparatuses simultaneously shooting, has its video being distributed or may be information indicating one image capture apparatus, from among the plurality of image capture apparatuses, which is the only image capture apparatus shooting and distributing video. The current shot name determination unit A 306 may identify the current camera control parameter based on the information received by the video stream receiving unit 302, for example, or may identify the current camera control parameter based on the input of settings by the user.

The question text generation unit 307 generates question text for the next camera control parameter based on the current camera control parameter and the audio text generated by the audio text generation unit 303. The question text generation unit 307 can generate question text based on a question template, for example. The question text generation unit 307, for example, can generate question text by identifying the speaker name of the audio text and inserting the speaker name into the person name frame in the question template and the audio text content in the spoken content frame.

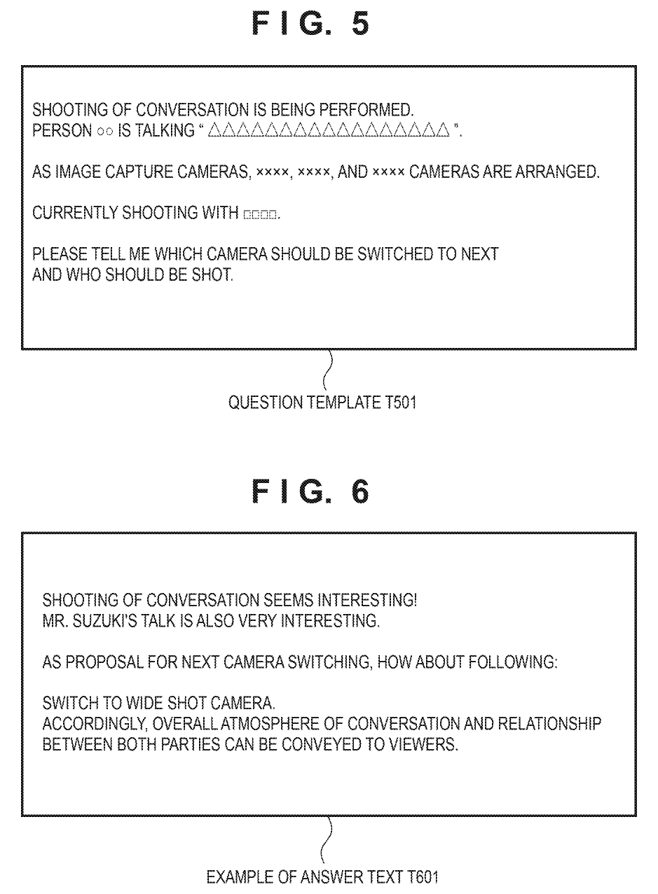

FIG. 5 is a diagram illustrating an example of a question template used when the question text generation unit 307 generates question text. In FIG. 5, a question template T501 corresponding to a question template is displayed on the screen. In the “Person ○○ “∆∆∆”” section in the question template, the question text generation unit 307 inserts the speaker name of the audio generated by the audio text generation unit 303 into the “Person ○○” section and the spoken content into the “∆∆∆” section. Also, the question text generation unit 307 lists the shot names of the image capture apparatuses connected to the information processing apparatus 103 set by the shot name setting unit A 304 into the question text (in this example, the “×” section). Here, for example, as the shot name, “Wide shot”, “Over-the-shoulder shot”, and “Reaction shot” are listed in the “×” section. Also, the question text generation unit 307 identifies the image capture apparatus distributing the current video based on the current camera control parameter and inserts the identified image capture apparatus into the “□” section in the question template. Via this processing, the question text generation unit 307 can generate question text.

The question text transmission unit 308 transmits the question text generated by the question text generation unit 307 to the inference apparatus 104.

The question text reception unit 311 receives the question text transmitted from the question text transmission unit 308.

The answer generation unit 312 generates an answer to the question by inputting the question text received by the question text reception unit 311 into a large language model. The answer generation unit 312 according to the present embodiment generates an answer to the question via an inference using the large language model trained using a large amount of text. The processing of generating an answer to a question using a large language model can be executed by discretionarily executing processing using a commonly used generative AI. Thus, the processing will not be described in detail.

FIG. 6 is a diagram illustrating an example of an answer to question text generated by the answer generation unit 312. When simply “answer text” is used below, this refers to the answer to the input question text generated by the answer generation unit 312 in this manner.

Here, the answer text includes, as information relating to the next camera control parameter, a proposal for the next image capture apparatus (shot name) to perform video distribution. The answer generation unit 312 can generate an answer based on the context of the spoken content included in the obtained question text. Also, the answer generation unit 312 may generate an answer also based on the context of the question text previously answered (based on question history).

The answer transmission unit 313 transmits the answer text generated by the answer generation unit 312 to the information processing apparatus 103.

The answer text reception unit 310 receives the answer text transmitted by the answer transmission unit 313.

The next shot name determination unit 309 determines the next camera control parameter based on the answer text generated by the answer generation unit 312. Here, the next shot name determination unit 309, from among the shot name set by the shot name setting unit A 304, derives the shot name closest to the proposed one based on the information (in this example, the shot name) indicating the image capture apparatus proposed to distribute video next in the answer text. This derivation may be performed by selecting the one with the highest similarity score calculated via text similarity calculation. In calculating the text similarity, first, the text which is the target of similarity calculation is vectorized using a neural network model trained in advance. Here, the answer text and the shot name text are vectorized, and the cosine similarity of the two vectors is calculated as the similarity score. This similarity score calculation processing is an example, and a different method may be used as long as the similarity of two pieces of text can be evaluated. The next shot name determination unit 309, via this processing, can determine the shot name derived as being the closest to the proposed shot name as the one to distribute video next.

The video selection unit 305 can output video of the shot name determined by the next shot name determination unit 309 in this manner as the next for distribution.

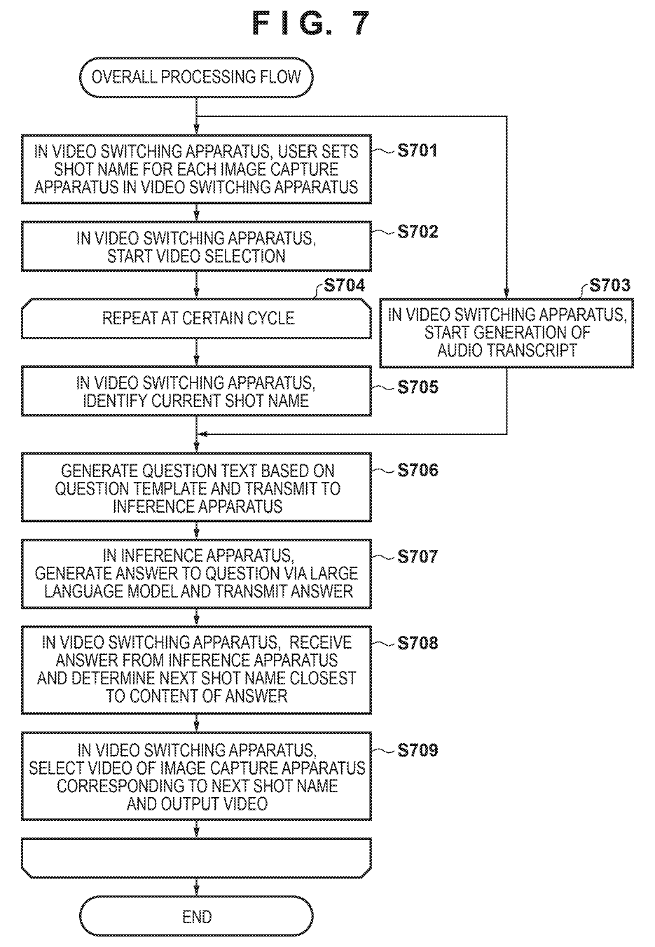

FIG. 7 is a flowchart illustrating an example of the video switch output processing in the image capture system according to the present embodiment. The processing illustrated in FIG. 7 starts when the user inputs a start operation, for example.

In S701, the shot name setting unit A 304 sets the shot name for each image capture apparatus. Here, the shot name setting unit A 304 sets the shot name based on a user input.

In S702, the video selection unit 305 starts video selection processing.

In S703, the audio text generation unit 303 generates audio text based on the obtained audio.

In S704, the information processing apparatus 103 starts loop processing of a certain cycle from S705 to S709.

In S705, the current shot name determination unit A 306 identifies the current camera control parameter. Here, the current shot name determination unit A 306 identifies the currently used shot name.

In S706, the question text generation unit 307 and the question text transmission unit 308 generate question text and transmit it to the inference apparatus 104.

In S707, the answer generation unit 312 generates answer text to the question text transmitted in S706 and transmits it to the information processing apparatus 103.

In S708, the next shot name determination unit 309 determines the next camera control parameter based on the answer text generated in S707. Here, the next shot name determination unit 309 determines, from among the shot names for each image capture apparatus set in S701, the camera control parameter corresponding to the next shot name closest to the answer content as the next camera control parameter.

In S709, the video selection unit 305 selects the video of the image capture apparatus corresponding to the next shot name determined in S708 and outputs it as distributed video. In a case where the loop processing continues, after the processing of S709, the processing returns to S705. In a case where the loop processing has ended, the processing ends at S709.

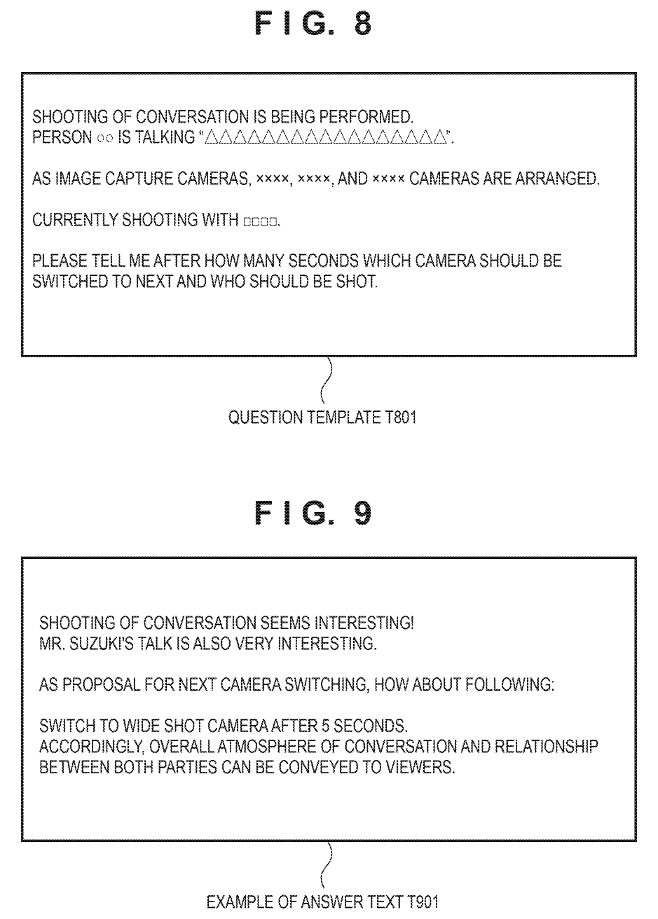

Note that in S704, the cycle of the started loop processing may be a constant cycle or a variable cycle. For example, the question text generated in S706 may include a question relating to the amount of time (loop processing cycle) until the next video switch as illustrated in FIG. 8, and in S707, a proposal answer (such as that illustrated in FIG. 9, for example) for the amount of time until the next video switch may be obtained. In this case, in S709, at the point in time when the loop cycle indicated as a proposal in the answer text has elapsed, the video selection unit 305 may select and output video and may transition to the next loop processing. Accordingly, video selection can be performed at a timing that suits the context.

In this manner, the information processing apparatus 103 according to the present embodiment can set a cycle for determining the next camera control parameter based on the answer to the question text as the “loop processing cycle”. Thus, the information processing apparatus 103 can include text for questioning about the cycle for determining the next camera control parameter in the generated question text.

According to such a configuration, question text for the next camera control parameter can be generated based on the identified current camera control parameter and the audio text of the obtained audio. Next, the answer text can be obtained by inputting the question text into a large language model, and the next camera control parameter can be determined based on the answer text. Accordingly, image capture apparatus parameter control can be performed based on the context of what is spoken. In particular, video selection and output can be performed in accordance with the shot of the current video output and the context of what is being spoken.

### Second Embodiment

In the first embodiment described above, as the camera control parameter, information indicating, from among a plurality of image capture apparatuses, an image capture apparatus to distribute video is used. However, in the second embodiment described below, as the camera control parameter, a pan value, a tilt value, and a zoom value for the image capture apparatus to distribute video is used.

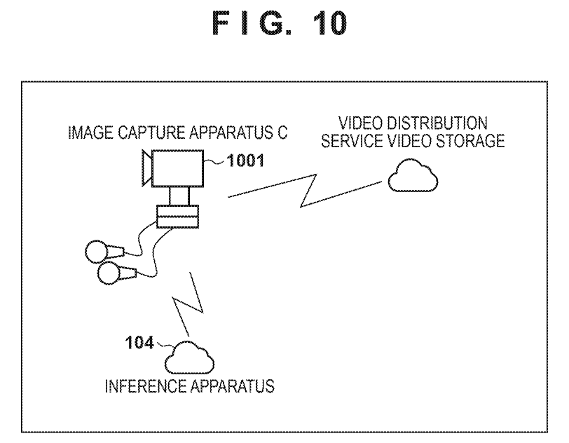

FIG. 10 is a schematic view illustrating an example of an image capture system configuration including an image capture apparatus C 1001 internally comprising an information processing apparatus according to the present embodiment. The image capture apparatus C 1001 is an image capture apparatus connected to the network that can execute pan, tilt, and zoom control. In the example described herein, the image capture apparatus C 1001 internally comprises the information processing apparatus 103 as described in the first embodiment. However, the image capture apparatus and the information processing apparatus 103 may be implemented as separate apparatuses as in the first embodiment. The image capture apparatus C 1001 can basically execute similar processing as the image capture apparatus A 101 and the image capture apparatus B 102 according to the first embodiment. The inference apparatus 104 is as described in the first embodiment.

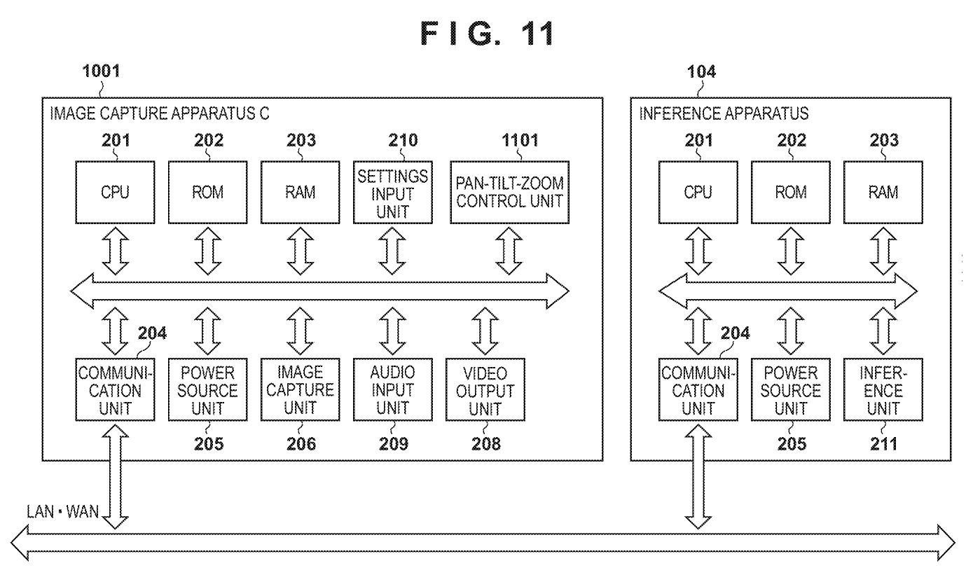

FIG. 11 is a block diagram illustrating an example of a hardware configuration of the image capture system according to the present embodiment. The image capture apparatus C 1001 includes the CPU 201, the ROM 202, the RAM 203, the communication unit 204, the power source unit 205, the image capture unit 206, the video output unit 208, the audio input unit 209, the settings input unit 210, and a pan-tilt-zoom control unit 1101, and these are all connected via a bus.

The CPU 201, the ROM 202, the RAM 203, the communication unit 204, the power source unit 205, the image capture unit 206, the video output unit 208, and the audio input unit 209 are as described in the first embodiment and thus will not be described here.

The pan-tilt-zoom control unit 1101 drives the motors for pan, tilt, and zoom control provided in the image capture apparatus and controls the pan, tilt, and zoom to a target position.

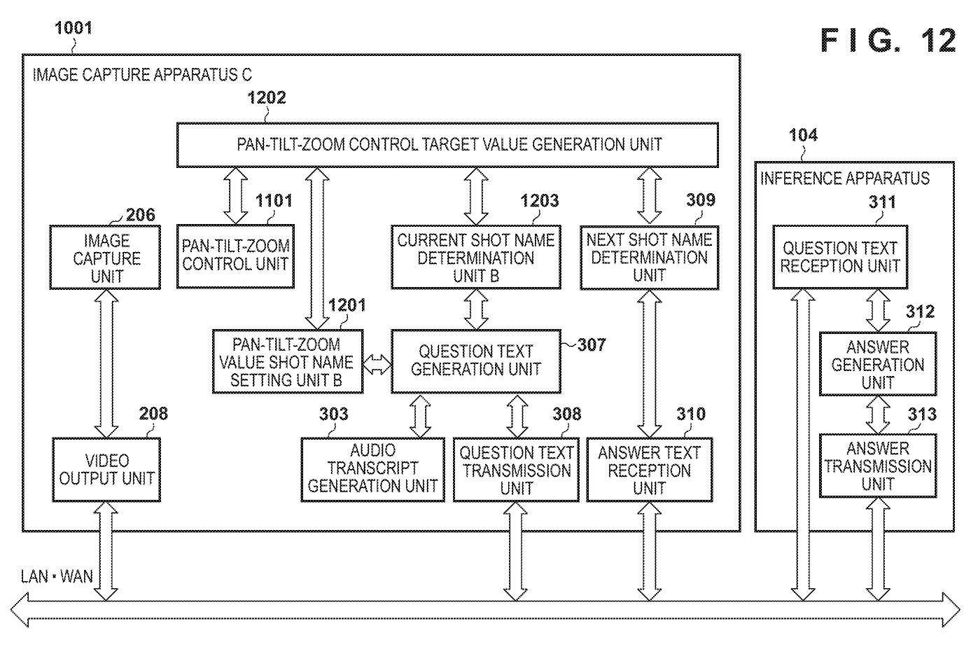

FIG. 12 is a block diagram illustrating an example of a functional configuration of the image capture system according to the present embodiment. The image capture apparatus C 1001 includes the image capture unit 206 and the video output unit 208 as described in the first embodiment. Also, the image capture apparatus C 1001 includes the audio text generation unit 303, the video selection unit 305, a current shot name determination unit A 306, the question text generation unit 307, the question text transmission unit 308, the next shot name determination unit 309, and the answer text reception unit 310 as described in the first embodiment. Also, the image capture apparatus C 1001 includes the pan-tilt-zoom control unit 1101, a pan-tilt-zoom value shot name setting unit B 1201, and a pan-tilt-zoom control target value generation unit 1202. The functional units that share a reference number with a functional unit of the first embodiment can execute similar processing and thus will not be described here.

The pan-tilt-zoom value shot name setting unit B 1201 sets the shot name for a preset combination of pan-tilt-zoom values (set in advance, for example). For example, the pan-tilt-zoom value shot name setting unit B 1201 can set the shot name based on a user input input by a user using the settings input unit 210.

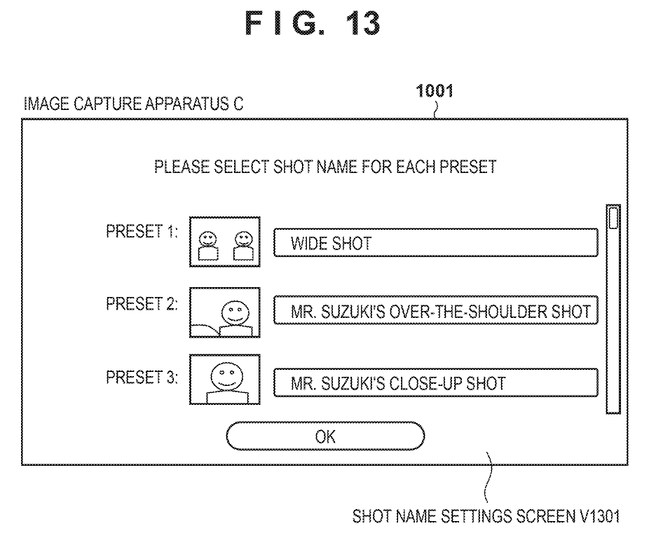

FIG. 13 illustrates an example of a settings screen for setting a shot name according to the present embodiment. A settings screen V 1301 is a screen for setting a shot name for a list of preset combinations of pan-tilt-zoom values. In the example of FIG. 13, the “Wide shot” shot name is set to a preset of pan-tilt-zoom values for capturing two people in a wide-angle when there are two subject persons. By displaying a preview of the video for each preset, the screen can make it easy for the user to perform the settings, as is the case with the settings screen V 1301. Note that the shot name is set by the user inputting the shot name as text in this example. However, the shot name may be set via a different method, such as the shot name being generated via image analysis technology, for example.

The pan-tilt-zoom control target value generation unit 1202 determines the next camera control parameter based on the answer text generated by the answer generation unit 312. In the present embodiment, the pan-tilt-zoom values are used as the camera control parameter described above. The pan-tilt-zoom control target value generation unit 1202 calculates the similarity score in a similar manner to the next shot name determination unit 309 of the first embodiment from among the shot names set by the pan-tilt-zoom value shot name setting unit B 1201 and determines the pan-tilt-zoom values corresponding to the shot name with the highest similarity score as the next camera control parameter.

A current shot name determination unit B 1203 identifies the current camera control parameter. In the present embodiment, the pan-tilt-zoom values are used as the camera control parameter described above. The current shot name determination unit B 1203 identifies the pan-tilt-zoom values of the current image capture apparatus C 1001 and identifies, from among the shots with a name set by the pan-tilt-zoom value shot name setting unit B 1201, the shot name corresponding to the identified pan-tilt-zoom values as the current shot name.

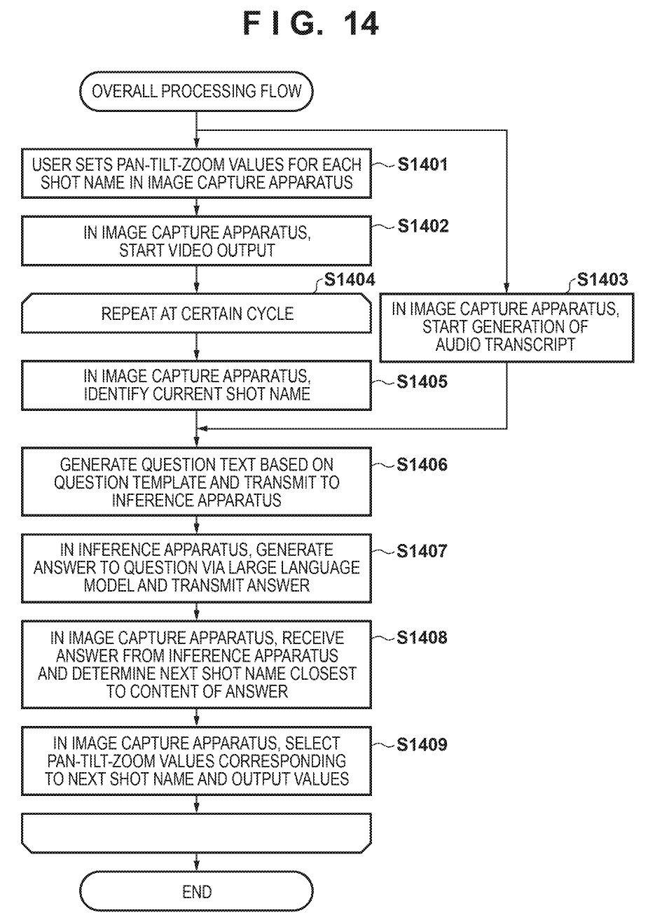

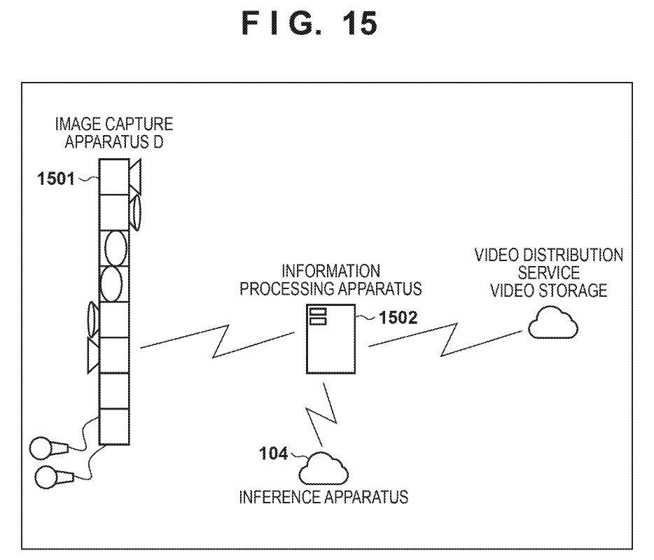

FIG. 14 is a flowchart illustrating an example of the video switch output processing in the image capture system according to the present embodiment. The processing illustrated in FIG. 14 starts when the user inputs a start operation, for example.

In S1401, the shot name setting unit B 1201 of each image capture apparatus sets a shot name for each combination of pan-tilt-zoom values. Here, the shot name setting unit B 1201 of each image capture apparatus sets the shot name based on a user input.

In S1402, the video selection unit 305 starts video selection processing.

In S1403, the audio text generation unit 303 generates audio text based on the obtained audio.

In S1404, the information processing apparatus 103 starts loop processing of a certain cycle from S1405 to S1409.

In S1405, the current shot name determination unit B 1203 identifies the current camera control parameter. Here, the current shot name determination unit B 1203 identifies the currently used shot name and obtains the pan-tilt-zoom values of the image capture apparatus currently shooting as the current camera control parameter.

In S1406, the question text generation unit 307 and the question text transmission unit 308 generate question text and transmit it to the inference apparatus 104.

In S1407, the answer generation unit 312 generates answer text to the question text transmitted in S1406 and transmits it to the image capture apparatus C 1001.

In S1408, the next shot name determination unit 309 determines the next camera control parameter based on the answer text generated in S1407. Here, the next shot name determination unit 309 determines, from among the shot names set in S1401, the camera control parameter corresponding to the next shot name closest to the answer content as the next camera control parameter.

In S1409, the pan-tilt-zoom control target value generation unit 1202 selects the video of the image capture apparatus corresponding to the next shot name determined in S1408 and outputs it as distributed video. In a case where the loop processing continues, after the processing of S1409, the processing returns to S1405. In a case where the loop processing has ended, the processing ends at S1409.

According to such a configuration, the pan-tilt-zoom values can be used as the camera control parameter. Thus, the orientation and zoom magnification of the image capture apparatus can be controlled in accordance with the shot of the current video output and the context of what is being spoken.

### Third Embodiment

In the first embodiment described above, as the camera control parameter, information indicating, from among a plurality of image capture apparatuses, an image capture apparatus to distribute video is used. However, in the third embodiment described below, as the camera control parameter, information indicating a partial region that is extracted from the video by the image capture apparatus and distributed is used.

FIG. 15 is a schematic view illustrating an example of an image capture system configuration including an image capture apparatus D 1501 and an information processing apparatus 1502 according to the present embodiment. Here, the image capture apparatus D 1501 is an image capture apparatus connected to a network that includes a plurality of image capture mechanisms and can capture 360-degree images of the surroundings. The image capture apparatus D 1501 can basically execute similar processing as the image capture apparatus A 101 and the image capture apparatus B 102 according to the first embodiment. The inference apparatus 104 is as described in the first embodiment.

The information processing apparatus 1502 according to the present embodiment generates a 360-degrees panorama video by joining together a plurality of videos output by the image capture apparatus D 1501 and sets a partial region in the panorama video to be extracted and distributed (frame extraction).

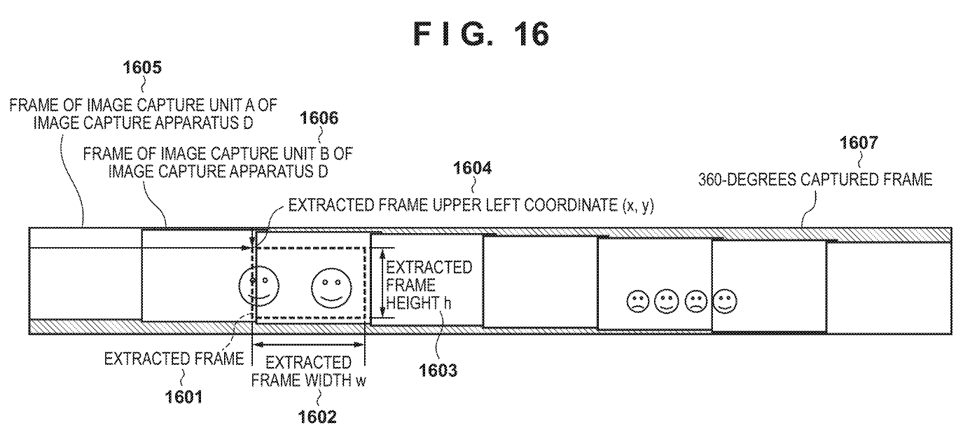

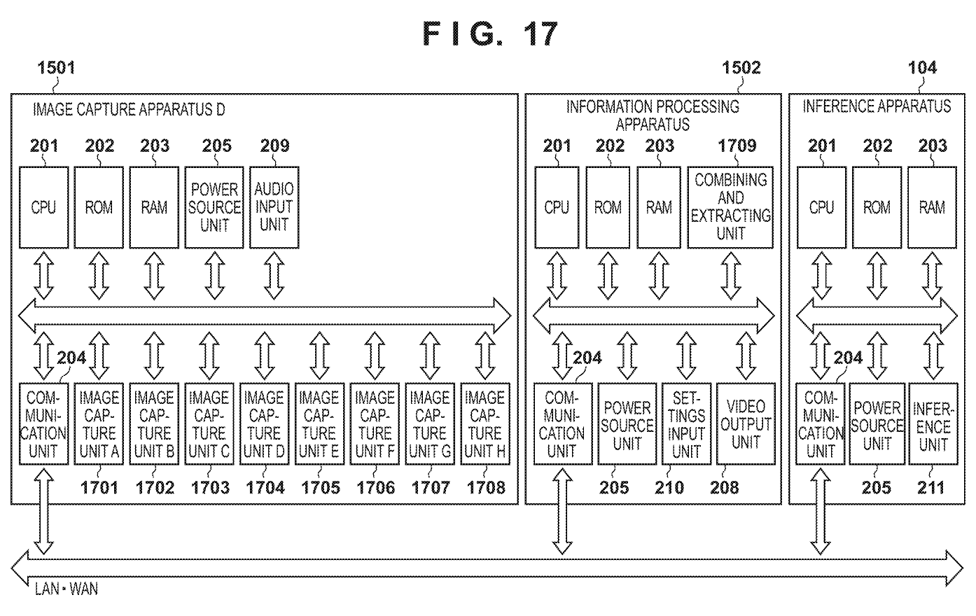

The frame extraction performed by the information processing apparatus 1502 will be described below with reference to FIG. 16. Here, the image capture apparatus D 1501 includes eight image capture apparatuses, with the panorama video being generated by combining the frames captured by the image capture unit of each image capture apparatus. Thus, in this example, the image capture apparatus D 1501 includes eight image capture units, image capture units A to H, and eight frames ranging from the frame of the image capture unit A to the frame of the image capture unit H exist. In the example of FIG. 16, the information processing apparatus 1502 generates a 360-degrees captured frame 1607 by combining these eight frames. Here, as an extracted partial region from the captured frame 1607, the information processing apparatus 1502 can extract and output an extracted frame 1601 by determining an extracted frame upper left coordinate (x, y) 1604, an extracted frame width w 1602, and an extracted frame height h 1603.

In the present embodiment, such information indicating the extracted frame 1601 (information indicating a partial region) is used as the camera control parameter. Also, in the present embodiment, a frame is extracted from a panorama video generated by combining a plurality of videos (images). However, extraction to obtain a partial region for distribution may be performed from a single captured image. Also, the panorama image may be captured using a wide-angle lens such as a fisheye lens.

FIG. 17 is a block diagram illustrating an example of a hardware configuration of the image capture system according to the present embodiment. The image capture apparatus D 1501 includes the CPU 201, the ROM 202, the RAM 203, the communication unit 204, the power source unit 205, the image capture unit, and the audio input unit 209, and these are all connected via a bus. The image capture apparatus D 1501 also includes, as image capture units, an image capture unit A 1701, an image capture unit B 1702, an image capture unit C 1703, an image capture unit D 1704, an image capture unit E 1705, an image capture unit F 1706, an image capture unit G 1707, and an image capture unit H 1708.

The CPU 201, the ROM 202, the RAM 203, the communication unit 204, the power source unit 205, the video output unit 208, and the audio input unit 209 are as described in the first embodiment and thus will not be described here. The image capture unit A 1701, the image capture unit B 1702, the image capture unit C 1703, the image capture unit D 1704, the image capture unit E 1705, the image capture unit F 1706, the image capture unit G 1707, and the image capture unit H 1708 are all hardware similar to the image capture unit 206.

The information processing apparatus 1502 includes the CPU 201, the ROM 202, the RAM 203, the communication unit 204, the power source unit 205, the video output unit 208, the settings input unit 210, and a combining and extracting unit 1709, and these are all connected via a bus. The CPU 201, the ROM 202, the RAM 203, the communication unit 204, the power source unit 205, the video output unit 208, and the settings input unit 210 are as described in the first embodiment and thus will not be described here.

The combining and extracting unit 1709 combines and extracts the video frames as described above. The inference apparatus 104 is as described in the first embodiment.

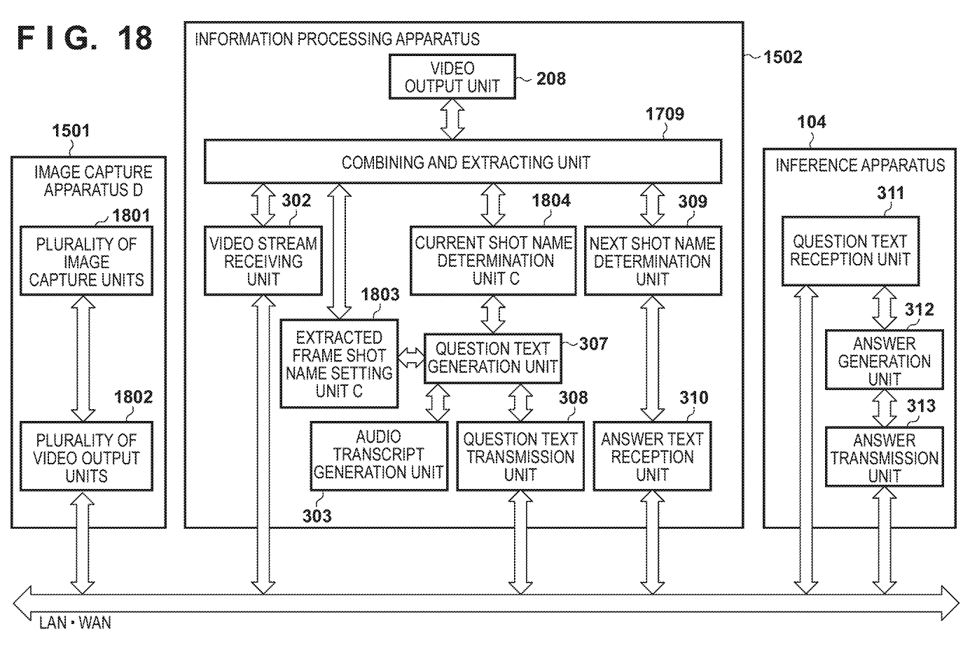

FIG. 18 is a block diagram illustrating an example of a functional configuration of the image capture system according to the present embodiment. The image capture apparatus D 1501 includes a plurality of image capture units 1801 and a plurality of video output units 1802. The plurality of image capture units 1801 refers to the image capture unit A 1701, the image capture unit B 1702, the image capture unit C 1703, the image capture unit D 1704, the image capture unit E 1705, the image capture unit F 1706, the image capture unit G 1707, and the image capture unit H 1708 described above. The plurality of video output units 1802 respectively output video from the plurality of image capture units 1801.

The information processing apparatus 1502 includes the video stream receiving unit 302, the audio text generation unit 303, the question text generation unit 307, the question text transmission unit 308, the next shot name determination unit 309, the answer text reception unit 310, and the video output unit 208. Also, the information processing apparatus 1502 includes the combining and extracting unit 1709, an extracted frame shot name setting unit C 1803, a current shot name determination unit C 1804. The functional units that share a reference number with a functional unit of the first embodiment can execute similar processing and thus will not be described here.

The extracted frame shot name setting unit C 1803 sets the shot name for the extracted frame position and size via the user using the settings input unit 210. For example, “Wide shot” is set as the shot name for an extracted frame in which two people are captured in a wide-angle when there are two subject persons. The current shot name determination unit C 1804 outputs the shot name set by the extracted frame shot name setting unit C 1803 for the current extracted frame position and size.

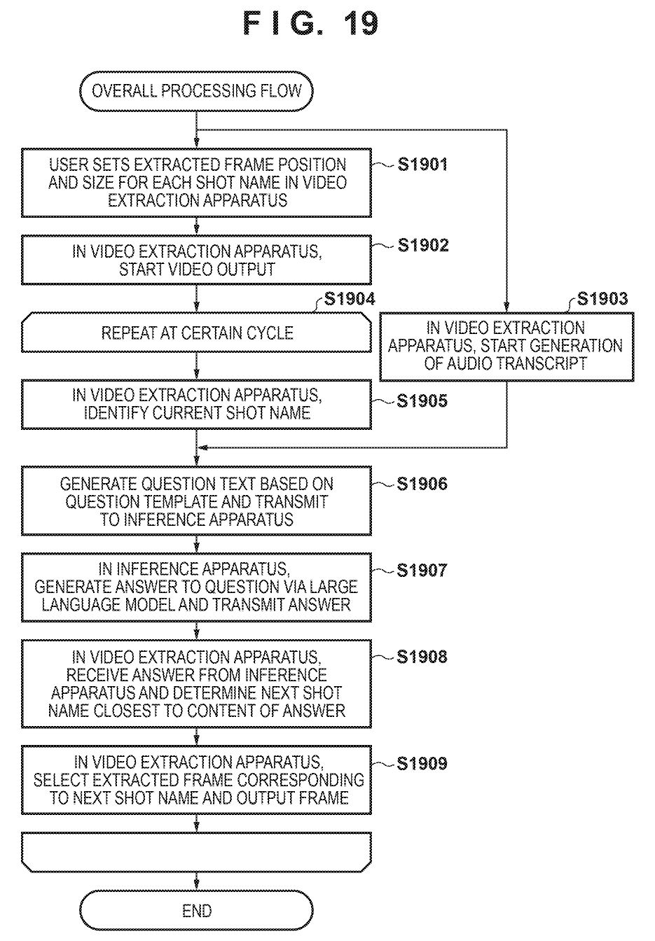

FIG. 19 is a flowchart illustrating an example of the video output processing in the image capture system according to the present embodiment. The processing illustrated in FIG. 19 starts when the user inputs a start operation, for example.

In S1901, the extracted frame shot name setting unit C 1803 sets the extracted frame position and size (extracted partial region position and size) for each shot name.

In S1902, the information processing apparatus 1502 starts video output.

In S1903, the audio text generation unit 303 generates audio text based on the obtained audio.

In S1904, the information processing apparatus 1502 starts loop processing of a certain cycle from S1905 to S1909.

In S1905, the current shot name determination unit C 1804 identifies the current camera control parameter. Here, the current shot name determination unit C 1804 identifies the currently used shot name and obtains the position and size of the partial region extracted from the video for the image capture apparatus currently shooting as the current camera control parameter.

In S1906, the question text generation unit 307 and the question text transmission unit 308 generate question text and transmit it to the inference apparatus 104.

In S1907, the answer generation unit 312 generates answer text to the question text transmitted in S706 and transmits it to the information processing apparatus 1502.

In S1908, the next shot name determination unit 309 determines the next camera control parameter based on the answer text generated in S1907. Here, the next shot name determination unit 309 determines, from among the shot names set in S1901, the camera control parameter corresponding to the next shot name closest to the answer content as the next camera control parameter.

In S1909, the combining and extracting unit 1709 extracts video of the extracted frame position and size based on the next camera control parameter determined in S1408 (corresponding to the next shot name) and outputs it as distributed video. In a case where the loop processing continues, after the processing of S1909, the processing returns to S1905. In a case where the loop processing has ended, the processing ends at S1909.

According to such a configuration, information indicating a partial region to be extracted and distributed can be used as the camera control parameter. Thus, the video extraction position and size can be determined in accordance with the shot of the current video output and the context of what is being spoken, and shooting that suits the context can be performed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-068955, filed Apr. 18, 2025, which is hereby incorporated by reference herein in its entirety.

What is claimed is:

1. An information processing apparatus comprising: one or more memories storing instructions; and
one or more processors executing the instructions to:
identify a current control parameter for an image capture apparatus, generate text of content of obtained audio,
generate question text relating to a next control parameter for the image capture apparatus based on the control parameter and the text,
obtain an answer to the question text by inputting the question text into a large language model, and
determine a next control parameter for the image capture apparatus based on the answer.

2. The information processing apparatus according to claim 1, wherein
the control parameter is a parameter indicating, from among a plurality of image capture apparatuses, an image capture apparatus that is to distribute video.

3. The information processing apparatus according to claim 2, wherein
the question text includes a speaker name of the audio, text of the content of the audio, and text for questioning which image capture apparatus, from among the plurality of image capture apparatuses, is to distribute video.

4. The information processing apparatus according to claim 1, wherein
the control parameter is information indicating a state of an orientation or a zoom magnification of the image capture apparatus.

5. The information processing apparatus according to claim 1, wherein
the control parameter is information indicating a partial region to be distributed in a captured image from the image capture apparatus.

6. The information processing apparatus according to claim 5, wherein
the captured image is a panorama image obtained by compositing images captured by a plurality of image capture apparatuses.

7. The information processing apparatus according to claim 1, wherein
the question text includes, as text, information indicating an image capture apparatus, which is set in association with each image capture apparatus included in a plurality of image capture apparatuses, and the current control parameter.

8. The information processing apparatus according to claim 7, wherein
the next control parameter is determined based on a similarity between the information indicating the image capture apparatus and information included in the answer.

9. The information processing apparatus according to claim 8, wherein
the next control parameter is a control parameter for, from among the plurality of image capture apparatuses, an image capture apparatus for which the information indicating the image capture apparatus is most similar to the information included in the answer.

10. The information processing apparatus according to claim 1, wherein
the large language model is a large language model that generates an answer based on a history of previously input question text.

11. The information processing apparatus according to claim 1, wherein
the question text includes text for questioning a cycle at which the next control parameter is to be determined, and
the one or more processors further execute the instructions to set a cycle of determination of the next control parameter based on the answer.

12. An information processing method comprising:
identifying a current control parameter for an image capture apparatus, generating text of content of obtained audio,
generating question text relating to a next control parameter for the image capture apparatus based on the control parameter and the text,
obtaining an answer to the question text by inputting the question text into a large language model, and
determining a next control parameter for the image capture apparatus based on the answer.

13. A non-transitory computer-readable storage medium configured to store a computer program comprising instructions for executing following processes:
identifying a current control parameter for an image capture apparatus, generating text of content of obtained audio,
generating question text relating to a next control parameter for the image capture apparatus based on the control parameter and the text,
obtaining an answer to the question text by inputting the question text into a large language model, and
determining a next control parameter for the image capture apparatus based on the answer.
